(19) United States
(12) Patent Application Publication
(10) Pub. No.: US 2002/0052749 A1
(43) Pub. Date: May 2, 2002

(54) Method and system for case conversion

(75) Inventor: Joachim Manfred Bauer, Boeblingen (DE)

Correspondence Address: IBM Corporation, 2455 South Road M/S P386, Poughkeepsie, NY, 12601, US

(73) Assignee: INTERNATIONAL BUSINESS MACHINES CORPORATION, ARMONK, NY (US)

(21) Appl. No.: 09/933,614

(22) Filed: Aug. 21, 2001

(30) Foreign Application Priority Data
Aug. 22, 2000 (EP) 00117994.4

(51) Int. Cl. G10L 11/00; G06F 17/28; G10L 21/00

(52) U.S. Cl. 704/277

(57) ABSTRACT

The present invention relates to a method and system for converting a first set of elements into a second set of elements, more particularly, to case conversion, e.g., according to the Unicode standard. It exploits a fast translation function provided by a computer system to speed up the conversion process. According to the present invention, the first set of elements is split into a first subset consisting of such elements getting translated to one particular element of said second set and into a second subset consisting of the remaining elements of said first set. A first table is composed in which each element belonging to the first subset is assigned to the respective element of the second set and all elements of said second subset are assigned to an exception handling element. A second table is composed representing rules according to which an exception handling function translates said elements of said second subset. A block of data to be converted is determined, whereby said data is formed by elements of said first set. Then, the first and second table and said determined block of data are provided to said translation function. Finally, the translation function is processed.

### BACKGROUND OF THE INVENTION

1. Field of the Invention

The present invention relates to a method and system for converting a first set of elements into a second set of elements. More particularly, the present invention relates to a method and system for case conversion, i.e., characters having a particular property, such as lowercase, uppercase or titlecase, are converted into characters having a different one of such properties.

2. Description of the Related Art

Companies often develop an initial version of a system or program that just deals with one particular language, e.g., English. Normally, it is just a matter of time when a version of the system or program is needed that can handle a different language. A common approach is still to just go through all the lines of code, and translate the literal strings.

This might be an acceptable approach in case the system or program is only needed in one additional language since the translation is a time-consuming process. Not all literal strings might need to be translated. Therefore, the translation process requires human judgment. Moreover, each new version of the system or program needs to be prepared in the same way, costing resources, time and money. In addition, since the company ends up having multiple versions of the program code, maintenance and support becomes more expensive as well. This is, because every change of the program code needs to be applied to each of the different language versions. Not even thinking about the danger that a translator may introduce bugs by mistakenly modifying code.

More and more, the companies address the aforementioned multi-lingual issue earlier in system design. A general technique to internationalize systems and programs is to separate literal strings from the program code so that the program code never needs modification because of adapting the program to different languages. It can be achieved by providing separate files containing the translatable information. However, this needs to be addressed during the program design or it requires a number of modifications to the code.

All translatable strings need to be moved into separate files, so called resource files, and the program code needs to be changed, in order to be enabled to access those strings when needed. These resource files can be flat text files, databases, or even code resources, but they are completely separate from the main code, and contain nothing but the translatable data.

Programs having such changes applied to meet the fundamental requirements to function in different international environments. In order to localize such a system or program, i.e., to adapt such a system or program to requirements of a different country, only the resource files need to be translated. Thus, no changes in the program code might be involved. It might not even be necessary to have programmers doing the translation. The resource files might just be handed over to a translation agency to modify.

However, this only solves one aspect of the multi-lingual issue, namely, how to provide a system or program with a translation of labels, menus or user messages. Another issue is to display the translated strings on the screen. As long as the same character set can be used for the different languages, it might be straight forward. However, different European languages are already using quite a few different characters besides the widely used characters ‘a’ to ‘z’. Furthermore, there are languages that are not even using the Latin alphabet, such as, most of the Slavic languages that are using the Cyrillic alphabet or the Greek language using the Greek alphabet and so on.

In order to solve this issue different character sets are needed which used to be encoded using different codepages. Nowadays, internationalized systems and programs are using a universal character encoding standard, such as ISO/IEC 10646 (International Organization for Standardization/International Electrotechnical Commission) or the Unicode Standard.

By using such a standard, a single internationalization process can be implemented that handles the requirements of all the world markets at the same time. Since such standards provide a single definition for each character, it handles the characters for all the world markets in a uniform way and it avoids the complexities of different character code architectures.

Now, the thus prepared systems and programs can handle different translations of labels, menus and user messages. They can display such messages in the appropriate character set and are able to store all literal information without a danger of data corruption because of mixed up character sets. However, there is still more functionality needed to provide full internationalization.

A majority of systems and programs, in particular, word processors, data bases and search engines, need to provide the functionality of case conversion. A “case” is a feature of certain alphabets where the letters have two distinct forms. These variants, which may differ markedly in shape and size, are called ‘uppercase letter’, also known as ‘capital’ or ‘majuscule’, and ‘lowercase letter’, also known as ‘small’ or ‘minuscule.’ Hence, it is a normative property of characters. Besides the properties uppercase and lowercase a third one is distinguished in case conversion it is called ‘titlecase.’ ‘Titlecase’ means an uppercased initial letter followed by lowercase letters in a word. This is a convention often used in titles, headers, and entries, as for example in a dictionary, glossary or a table of contents.

Case conversion, however, is not trivial, since depending on the particular language alike letters might have to be treated differently. This is because of their particular case mapping, i.e., the association of the uppercase form, lowercase form, and titlecase form of a letter. Particular characters may expand to two characters when converted to uppercase, they may have different case mappings depending on the context or they may have case mappings that differ from language to language.

A state of the art approach addresses the aforementioned issue by doing the case conversion character by character having the special cases hard-coded. For each character it is checked whether a different conversion is needed because of the language or position of the character under consideration.

From U.S. Pat. No. 6,055,365 a method is known of using a computer to translate a source text whose glyphs and control codes are represented by a string of code points from a set of source code points to a destination text whose glyphs and control codes are represented by a string of code points from a set of destination code points. The method comprises the steps of accessing a translation state table, whereby the translation state table has at least one row of cells and each row has an associated state value. The cells, however, are indexed by the source code points. A current state is used to select a row of the translation state table. Then, an input code point sequence from the source text is used to select a cell within the row. If the cell contains a next state value, then the steps of using the current state and of using an input code point sequence is repeated until a desired destination code point sequence is provided. Later, the current state is updated with a next state value, and finally, the steps of using a current state, using an input code point sequence, and repeating, is repeated for each next input code point sequence.

The described method teaches to implements a general purpose state machine as a computer program. The general purpose state machine needs a lookup step for every single byte in the input stream to determine the next state. This creates a lot of overhead that slows down the processing.

It is therefore an object of the present invention to provide a method and a system having an improved processing speed.

### SUMMARY OF THE INVENTION

The foregoing object is achieved by a method and a system for converting a first set of elements into a second set of elements, whereby at least one element of the first set has a context dependent relation to one or more elements of the second set according to the independent claims. The expression ‘context’ not only refers to elements before and after the element under consideration, but also to the whole surroundings that gives meaning to the conversion process. For example, in case characters need to get converted, the context might also be the language the characters are used in, or the encoding scheme being used.

The focus of the invention is on speed. Therefore, the method and system seek to utilize basic functionality for translating elements already provided on a computer system to be used in conjunction with the present invention. The provided basic functionality for translating elements, in general, is simple but fast.

The present invention makes use of a standard translation function. The function that is used within the method and system according to the present invention is able to translate a block of elements of a first set into a block of elements of a second set. However, the provided function is purely able to handle a static relation between the elements of the first and the second set, i.e., an element of the first set gets translated into one particular element of the second set under all circumstances. In case a different treatment is required, the function needs to interrupt its processing and raise an exception. The relation between the elements of the first and the second set is provided to the function in form of a table specifying for each element of the first set either one particular element of the second set or an exception handling element in case no static relation exists. Whenever one element of the first set would be translated to such an exception handling element the function interrupts and an exception handling function gets executed.

Preferably, the function is implemented as a machine instruction, i.e., a function that gets processed at the hardware level of a computer. This makes the computation of the instruction much faster than a software implementation. Such a function that converts a whole batch of characters with one call, for example, exists on the S/390 hardware platform manufactured by International Business Machines Corporation. On this hardware platform the particular function is called TRTT (Translate Two to Two).

However, since the required function only provides a simple translation process a software implementation, e.g., in machine code, i.e., a representation of a computer program that is actually read and interpreted by a computer, might be sufficiently fast.

In order to exploit the simple but fast translation function provided by the computer system to be used, according to the present invention, the first set of elements is split into a first subset consisting of such elements getting translated to one particular element of the second set and into a second subset consisting of the remaining elements of the first set. A first table is composed in which each element belonging to the first subset is assigned to the respective element of the second set and all elements of the second subset are assigned to an exception handling element. A second table is composed representing rules according to which an exception handling function translates the elements of the second subset. A block of data to be converted is determined, whereby the data is formed by elements of the first set. Then, the first and the second table and the determined block of data are provided to the translation function. Finally, the translation function is processed.

### BRIEF DESCRIPTION OF THE DRAWINGS

The above, as well as additional objectives, features and advantages of the present invention, will be apparent in the following detailed written description.

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 illustrates a generation of a first table being used in the method and system according to the present invention;

FIG. 2 shows a flow chart depicting a first mode of operation of the method and system according to the present invention;

FIG. 3 shows a flow chart depicting a second mode of operation of the method and system according to the present invention;

FIG. 4 shows a detailed view of a table defining special rules for context dependent case conversion; and

FIG. 5 illustrates the generation of the table of FIG. 4.

### DETAILED DESCRIPTION OF THE INVENTION

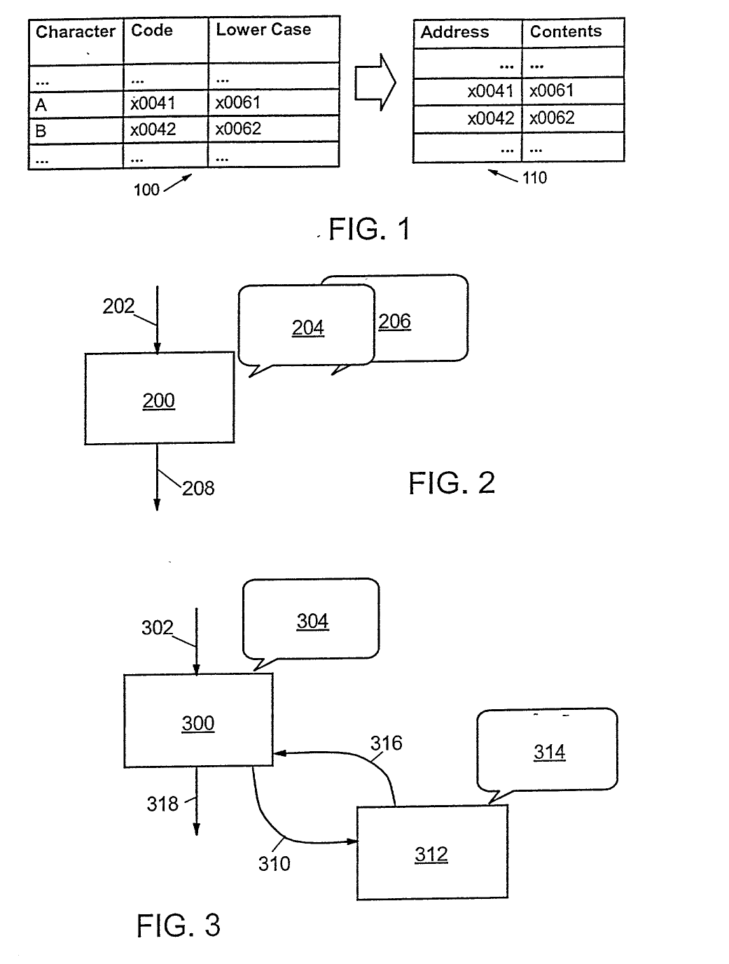

With reference to FIG. 1, there is depicted a first chart 100 having a first column 102, a second column 104 and a third column 106. The chart 100 defines a case conversion for different characters.

In the first column 102, the glyphs of all characters to be converted are depicted. A glyph is an image used in the visual representation of characters. The characters ‘A’ and ‘B’ in the first column 102 are only cited as an example. The dots in the first and the fourth row indicate that the chart is actually much larger covering all characters needed.

The second column lists the hexadecimal code of the characters ‘A’ and ‘B’, i.e., the representation of the respective characters in a given format. In the present illustration the characters A and B are encoded in an universal character encoding standard, following the ISO/IEC 10646 standard (International Organization for Standardization/International Electrotechnical Commission) and the Unicode Standard, respectively.

Finally, the third column shows the hexadecimal code of the lower case representation of the respective character A or B. In other words, whenever the character A having the hexadecimal code x0041 is meant to be converted into its lowercase representation, it has to be replaced by the hexadecimal code x0061. Of course, this is only true if the same encoding standard is being used. However, in case other encoding standards are used, a corresponding chart is provided. This chart cannot directly be used for an automated character conversion in accordance with the method and system for converting a first set of elements into a second set of elements provided by the present invention. Therefore, starting from the first chart 100 a first table 110 is composed as indicated by the arrow 112.

The first table 110 consists of a first column 114 and a second column 116. The first column lists the addresses of a linear block of memory cells and the second column 116 list the contents of the respective memory cells. The first chart 110 is now generated in a way that the code of a lowercase representation of a character is stored in the field of the second column that is indicated by the address that corresponds to the encoding of the character. In other words, the code of the characters to be converted are interpreted as addresses of a linear block of memory cells and the code representing the result of the case conversion is stored in the respective memory cells. For example, the hexadecimal code x0041 encoding the character ‘A’ now represents the address of a memory cell, that contains the lowercase representation x0061 of the character ‘A’ in the given universal encoding standard.

Thus, through the processing of the first chart 100 a block of memory cells is achieved, that contains the information about the character conversion originally stored in the first chart 100. Tables specifying the character conversion to uppercase and to title titlecase are composed in the same way. Of course, different charts need to be provided. Such charts can normally be acquired from the institutions setting up the respective universal encoding standards.

Now with reference to FIG. 2, there is depicted a flow chart showing a first mode of operation of the method and system according to the present invention. The block 200 illustrates a translation function provided by a computer system to be used in conjunction with the present invention. The translation function is able to convert a batch of characters with one call. The batch of characters is provided to the translation function by specifying the respective addresses where the batch of characters can be found. This is indicated by the first arrow 202.

In order to instruct the function how to translate the provided batch of data a previously composed table 204 is provided to the translation function. The table 204 corresponds to the first table 110 shown in FIG. 1. Alternatively, a different table 206 can be provided to the translation function instructing it to perform a different conversion. The table 204 enables the translation function to convert the inputted batch of characters into lowercase, whereas the different table 206, for example, would instruct the translation function to convert the provided batch of characters to uppercase. Finally, if the end of the supplied batch of characters, here the source, is reached the results are available for further processing, as indicated by the second arrow 208.

Up to now, the first mode of operation dealing with a basic scenario of case conversion has been described. In the basic scenario, a character is converted to one particular character under all circumstances. Case conversion, however, is not so trivial. Depending on the particular language alike letters may have to be treated differently.

Characters may expand to two characters when converted to uppercase. For example, the German character “β”, referred to as ‘Latin Small Letter Sharp S’, expands to the sequence of two characters ‘Latin Capital Letter S’.

Characters may have different case mappings, depending on the context. For example, the Greek character “Σ”, ‘Greek Capital Letter Sigma’, has a first lowercase representation “σ”, ‘Greek Small Letter Sigma’, if it is followed by another letter, and a second lowercase representation “ζ”, ‘Greek Small Letter Final Sigma’, if it is the last letter in a word.

Furthermore, characters may have case mappings that depend on the language. For example, in the Turkish language the letter ‘Latin Capital Letter I’ has got the lowercase representation of ‘Latin Small Letter Dotless I’, whereas in Turkish the letter ‘Latin Small Letter I’ has got the uppercase representation of ‘Capital Letter I With Dot Above’.

With reference to FIG. 3, a flow chart depicting a second mode of operation of the method and system according to the present invention is shown. In this mode of operation the method and system also deals with such characters that need a context dependent conversion.

The block 300 illustrates again a translation function provided by a computer system. The translation function is able to convert a batch of characters provided to the function, as indicated by a first arrow 302, with one call. The conversion is performed in accordance with a previously composed first table 304 provided to the translation function.

The first table 304 corresponds to the table 110 shown in FIG. 1, but shows some additional features. The table consists of a first and a second column. The first column lists the addresses of a linear block of memory cells and the second column list the contents of the respective memory cells, as already described in greater detail with reference to FIG. 1. In the first table 304, the contents of the memory cells is a special exception handling element, referred to as ‘stop element’, in such cases in which a context dependent conversion is required. Whenever the translation function translates a character to the stop element the translation function interrupts its processing and an exception handling function is executed, as illustrated by arrow 310. Block 312 illustrates the exception handling function. The execution of the exception handling function can be invoked either by the translation function itself or explicitly as part of the inventive method.

A previously composed second table 314 represents rules according to which exception handling function translates the characters requiring a context dependent conversion. After having determined the correct, context specific conversion, the exception handling function is terminated and the control of the process is returned to the translation function, as depicted by the arrow 316. The previously described processing steps are repeated automatically by the translation function until the whole batch of characters have been converted. If the end of the source is reached the translation function terminates and returns the converted batch of characters for further processing as indicated by the arrow 318.

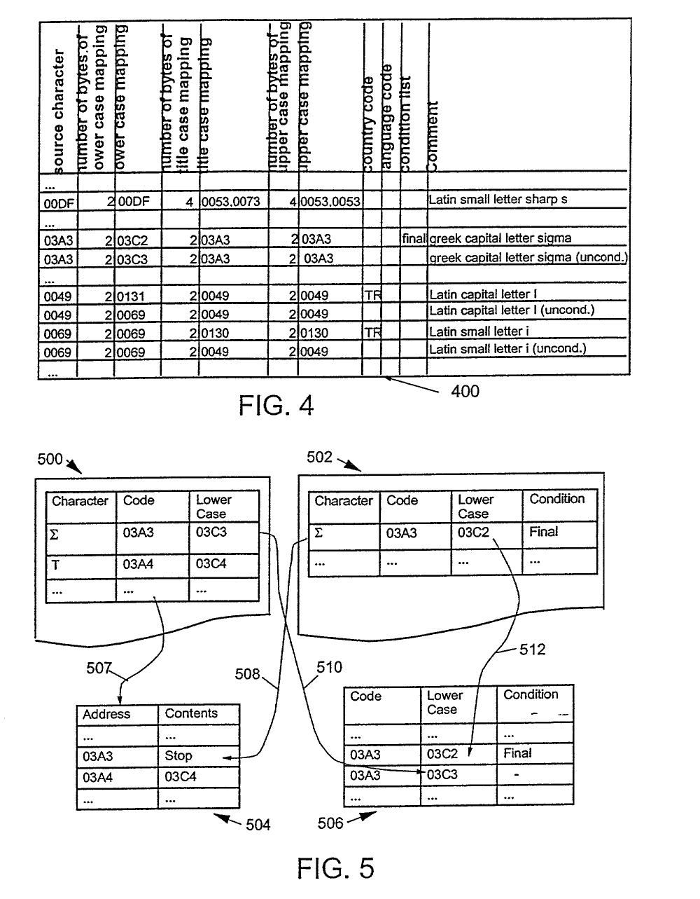

FIG. 4 shows a detailed view of a special casing table 400. The special casing table 400 corresponds to the second table 314 shown in FIG. 3. The expression ‘special casing’ refers to the rules according to which all context dependent characters get converted. The table consists of eleven columns, eleven rows and the column titles. It is acknowledged that the shown table forms only a small part of all the special casing needed. Further, the particular representation of the information as shown in the table is only one possible ways of representing it, e.g., the rows or columns can be arranged differently or the comments and column titles can be omitted at all. The dots in rows 1, 3, 6 and 11 indicate that other rows were not drawn purely for sake of clarity.

The first column contains the code of a source character. This is the character that is meant to be converted. The second column indicates the number of bytes of a lowercase mapping, whereas the third column specifies the code of the lowercase mapping. Correspondingly, the fourth column indicates the number of bytes of a titlecase mapping, the fifth column specifies the code of the titlecase mapping, the sixth column indicates the number of bytes of an uppercase mapping and the seventh column specifies the code of the uppercase mapping. The eighth column contains a country code. A language code is provided in the ninth column. The tenth column keeps a condition list and, finally, the eleventh column provides some comments.

With reference to the second row, there is depicted an example of a character expanding to two characters when converted to uppercase. The hexadecimal code x00DF encodes the German character “β”, referred to as ‘Latin Small Letter Sharp S’. The lowercase mapping is identically encoded in two bytes, since it is already lowercase. In uppercase or titlecase it expands to the sequence of two characters ‘Latin Capital Letter S’ encoded as x0053, x0053 now having a length of four bytes.

If a characters has got a different case mappings, depending on particular conditions, more than one row is required for the same character to represent the conversion rules, one for each condition. The fourth and fifth row show the example of the Greek character “Σ”, ‘Greek Capital Letter Sigma’, having the hexadecimal code x03A3. The fourth row show a scenario if the character is the last one in a word, as indicated by the condition ‘final’. In this scenario the character gets converted to its lowercase representation “σ”, ‘Greek Small Letter Sigma’, having the hexadecimal code x03C2. If the letter is not the last one in a word, its lowercase representation is “70 ”, ‘Greek Small Letter Final Sigma’, having the hexadecimal code x03C3 is used.

The seventh and the ninth row show an example wherein common Latin capital and small letters need to be treated differently because of the language they occur in. In the Turkish language the letter ‘Latin Capital Letter I’ having the hexadecimal code x0049 has got the lowercase representation of ‘Latin Small Letter Dotless I’ having the hexadecimal code x0131, whereas the letter ‘Latin Small Letter I’ with the hexadecimal code x0069 has got the uppercase representation of ‘Capital Letter I With Dot Above’ having the hexadecimal code x0130. Since this is only true for the Turkish language the country code shows ‘TR’. In the English language, for example, ‘Latin Capital Letter I’ having the hexadecimal code x0049 would be converted to ‘Latin Small Letter I’ with the hexadecimal code x0069 when changing to lowercase and vice versa, as shown in rows eight and ten.

Finally, with reference to FIG. 5, there is illustrated the generation of the special casing table as shown in FIG. 4. A first chart 500 having three columns lists all codes of characters to be translated and the codes of their lowercase mapping. In a second chart 502, there is a list of special casing. In addition to the columns shown in the first chart 500, in the second chart 502 a column ‘condition’ can be found indicating the condition for a special casing.

A first lowercase mapping for the Greek character “Σ”, ‘Greek Capital Letter Sigma’, is encoded by the hexadecimal code x03C3 standing for “σ”, ‘Greek Small Letter Sigma’. However, there is a second lowercase mapping for this character in the special casing chart 502. If the character to be converted is the last one in a word, as indicated by the condition ‘final’, then a different lowercase mapping is needed, here, hexadecimal code x03C2, standing for “ζ”, ‘Greek Small Letter Final Sigma’.

Now, a first table 504 and a second table 506 are composed from the information given in the aforementioned charts 500 and 502. The first table 504 contains all information of a regular treatment for a case conversion to lowercase. From the first chart the second column is taken that lists the codes of all different characters that might be converted, as indicated by arrow 507. Then as a lowercase mapping a ‘stop’ code is assigned for all characters that have an entry in the second chart specifying the special casing conditions, as indicated by arrow 508. For example, the hexadecimal code x03A3 has got two different lowercase mappings, as already mentioned. Therefore, there is the ‘stop’ in the same row. Consequently, the information from the first chart 500 and the special casing information from the second chart 502 are written to the second table 506, as indicated by arrows 510 and 512. Characters with only one lowercase mapping only show an entry in the first table 504.

Besides the characters that have different casings, there are also so called ‘uncased’ characters, i.e., characters that never change in a case conversion, such as, whitespace, i.e., any contiguous sequence of spaces, tabs, carriage returns, and/or line feeds, comma, full stop, semicolon, etc.

In another embodiment of the present invention the uncased characters are used to implement a table driven character conversion to titlecase. In a conversion to titlecase only characters at the beginning of a word get converted to uppercase. Before starting the conversion process by calling a standard translation function, as explained above, a special composed table is provided to the translation function. In this special table the contents field of all rows marked by codes of uncased characters are filled with a stop element indicating the need of a special treatment. Whenever a character gets translated to a stop element an exception handling function is called. Then, the exception handling function can determine the next cased character, as to be the opposite of an uncased character, and perform the conversion to uppercase. Hence, just by providing a different table a whole batch of characters can be converted to titlecase with one call to the translation function.

Another major advantage of the method and system according to the present invention lies in the fact that the translation function and the exception handling function can stay unchanged when new case mappings are coming up. Advantageously, no information about the treatment of a characters during case conversion is hard-coded, i.e., written directly into a program, possibly in multiple places, where it cannot be easily modified.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

Further, the present invention can advantageously be incorporated at least partly in a hardware implementation directly burnt-in into an integrated circuit, such as a hardware chip. The integrated circuit then comprises hardware implementing and reflecting at least parts of the steps of the inventive code conversion method. Considering the steadily growing diversity of telecommunication devices and their steadily increasing function range including more and more technical features such a chip can then be used in a large variety of devices. In view of devices available today such a chip can be advantageously used in any device which forms part of any international communication. For example, Internet servers, routers in any kind of network, e.g., the Internet, set-top boxes for TV or radio receiving devices, particularly digital TV or radio, mobile phones, any kind of hand held computing and/or telecommunication device or any other device having an input interface for processing any foreign-language data.

What is claimed is:

1. A method for converting a first set of elements into a second set of elements, at least one element of the first set having a context dependent relation to one or more elements of the second set, using a computer system providing a translation function for translating a block of elements of a first set into a block of elements of a second set in accordance with a table specifying for each element of said first set either one particular element of the second set or an exception handling element, said function being further provided to interrupt processing whenever an element is processed marked by an exception handling element in said table, so that an exception handling function can be executed, said method comprising the steps of:
splitting said first set of elements into a first subset consisting of such elements getting translated to one particular element of said second set and a second subset consisting of the remaining elements of said first set;
composing a first table in which each element belonging to the first subset is assigned to the respective element of the second set and all elements of said second subset are assigned to an exception handling element;
composing a second table representing rules according to which an exception handling function translates said elements of said second subset;
determining a block of data to be converted, whereby said data is formed by elements of said first set;
providing said first and second table and said determined block of data to said translation function; and
processing said translation function.

2. The method of claim 1 wherein said first set is formed by characters having a first property and said second set is formed by said characters having a second property.

3. The method of claim 2 wherein said first property and said second property are made up by lowercase, uppercase or titlecase.

4. The method of claim 1 wherein converting a first set of elements into a second set of elements is formed by a case conversion.

5. The method of claim 1 wherein said first set and said second set are formed by characters encoded in an universal character encoding standard used for representation of text for computer processing.

6. The method of claim 5 wherein said standard is the Unicode standard.

7. The method of claim 1 wherein the step of composing the first table includes the steps of:
determining the codes of all uncased characters; and
assigning in the first table to the determined codes of characters an exception handling character.

8. The method of claim 1 wherein there is further provided a first chart listing all codes of characters to be translated and the codes of their mapping into the different cases and a second chart containing a list of conditioned mappings, said step of composing the first table comprising the steps of:
taking from the first chart all codes of characters to be translated;
determining the codes of characters that have an entry in the second chart; and
assigning in the first table to the determined codes of characters an exception handling character.

9. The method of claim 1 wherein there is further provided a first chart listing all codes of characters to be translated and the codes of their mapping into the different cases and a second chart containing a list of conditioned mappings, said step of composing the second table including the steps of:
taking from the second chart all codes, mappings and conditions;
determining the codes of characters in the first chart that have an entry in the second chart; and
adding the determined codes of characters and the respective mappings to the second table.

10. A computer program product stored on a computer usable medium, comprising computer readable program means for causing a computer to perform the method of claim 1.

11. An integrated circuit comprising hardware implementing the steps of the method of claim 1.

12. A device comprising the integrated circuit of claim 11.

13. A computer program for execution in a data processing system comprising computer program cod e portions for performing respective steps of the method of claim 1.

14. The computer program of claim 13 comprising a browser program.

15. A system for converting a first set of elements into a second set of elements, at least one element of the first set having a context dependent relation to one or more elements of the second set, comprising a computer system providing a translation function for translating a block of elements of a first set into a block of elements of a second set in accordance with a table specifying for each element of said first set either one particular element of the second set or an exception handling element, said function being further provided to interrupt processing whenever an element is processed marked by an exception handling element in said table, so that an exception handling function can be executed, said computer system comprising:
a first portion configured to cause the computer system to split said first set of elements into a first subset consisting of such elements getting translated to one particular element of said second set and a second subset consisting of the remaining elements of said first set;
a second portion configured to cause the computer system to compose a first table in which each element belonging to the first subset is assigned to the respective element of the second set and all elements of said second subset are assigned to an exception handling element;
a third portion configured to cause the computer system to compose a second table representing rules according to which an exception handling function translates said elements of said second subset;
a fourth portion configured to cause the computer system to determine a block of data to be converted, whereby said data is formed by elements of said first set;
a fifth portion configured to cause the computer system to provide said first and second table and said determined block of data to said translation function; and
a sixth portion configured to cause the computer system to process said translation function.

16. The system of claim 15 arranged for being used as an Internet server.
